(19) United States
(12) Patent Application Publication
(10) Pub. No.: US 2025/0158096 A1
(43) Pub. Date: May 15, 2025

(54) FUEL CELL SYSTEM AND CONTROL METHOD

(71) Applicant: KOMATSU LTD., Tokyo (JP)

(72) Inventor: Hideyo EBISUZAKI, Tokyo (JP)

(21) Appl. No.: 18/833,528

(22) PCT Filed: Jan. 24, 2023
(86) PCT No.: PCT/JP2023/002005

§ 371 Date: Jul. 26, 2024

(30) Foreign Application Priority Data
Jan. 31, 2022 (JP) 2022-012814

(51) Int. Cl. H01M 8/04701; H01M 8/04029; H01M 8/0432; H01M 8/04858; H01M 8/249

(52) U.S. Cl. CPC H01M 8/04723; H01M 8/04029; H01M 8/0432; H01M 8/0491; H01M 8/249

(57) ABSTRACT

A fuel cell system includes a plurality of fuel cell modules, a temperature sensor configured to measure a temperature of each of the plurality of fuel cell modules, an output current control circuit configured to individually control an output current from each of the plurality of fuel cell modules, and a control device configured to control the output current control circuit on the basis of temperature information acquired through the temperature sensor.

### CROSS-REFERENCE TO RELATED APPLICATIONS

This application is a U.S. National stage application of International Application No. PCT/JP2023/002005, filed on Jan. 24, 2023. This U.S. National stage application claims priority under 35 U.S.C. § 119(a) to Japanese Patent Application No. 2022-012814, filed in Japan on Jan. 31, 2022, the entire contents of which are hereby incorporated herein by reference.

The present disclosure relates to a fuel cell system and a control method.

### Background

Japanese Unexamined Patent Application, First Publication No. 2020-057515

describes a fuel cell system in which each cell of a fuel cell is composed of a first power generation unit and a second power generation unit that surrounds the first power generation unit, and a current density of the first power generation unit is made smaller than a current density of the second power generation unit. According to the fuel cell system described in Japanese Unexamined Patent Application, First Publication No. 2020-057515, in each cell, heat generation can be suppressed on the center side of the cell, where heat dissipation is lower than on the outer circumferential side. Therefore, according to this fuel cell system, the temperature distribution within the cell can be made uniform.

### SUMMARY

### Background

A fuel cell is operated as a unit of a fuel cell stack, which is constructed by stacking a plurality of fuel cell batteries. In the present disclosure, a configuration including a fuel cell stack and other configurations related to the operation of the fuel cell stack are collectively referred to as a fuel cell module. According to the configuration described in Japanese Unexamined Patent Application, First Publication No. 2020-057515

, it is possible to achieve a uniform temperature distribution within each fuel cell battery included in each fuel cell module. However, in a case where the fuel cell system is configured using a plurality of fuel cell modules, there is a problem in that a demand for suppressing a temperature variation between the fuel cell modules is not met.

The present disclosure has been made in view of the above circumstances, and an object thereof is to provide a fuel cell system and a control method capable of suppressing a temperature variation between a plurality of fuel cell modules.

### SUMMARY

The present disclosure relates to a fuel cell system including a plurality of fuel cell modules, a temperature sensor provided so that a temperature of each of the fuel cell modules is measurable, an output current control circuit provided so that an output current from each of the fuel cell modules is individually controllable, and a control device configured to control the output current control circuit on the basis of temperature information acquired through the temperature sensor.

According to the fuel cell system and the control method of the present disclosure, a temperature variation between a plurality of fuel cell modules can be suppressed.

### BRIEF DESCRIPTION OF DRAWINGS

FIG. 1 is a block diagram showing a configuration example of a fuel cell system according to an embodiment of the present disclosure.

FIG. 2 is a block diagram showing a functional configuration of a control device according to a first embodiment of the present disclosure.

FIG. 3 is a schematic diagram for describing an operation example of the control device according to the embodiment of the present disclosure.

FIG. 4 is a flowchart showing an operation example of the control device according to the embodiment of the present disclosure.

FIG. 5 is a block diagram showing a functional configuration of a control device according to a second embodiment of the present disclosure.

### DESCRIPTION OF EMBODIMENTS

Embodiments of the present disclosure will be described below with reference to the drawings. In addition, in each drawing, the same reference numerals are used for the same or corresponding components, and the description thereof will be omitted as appropriate.

### First Embodiment

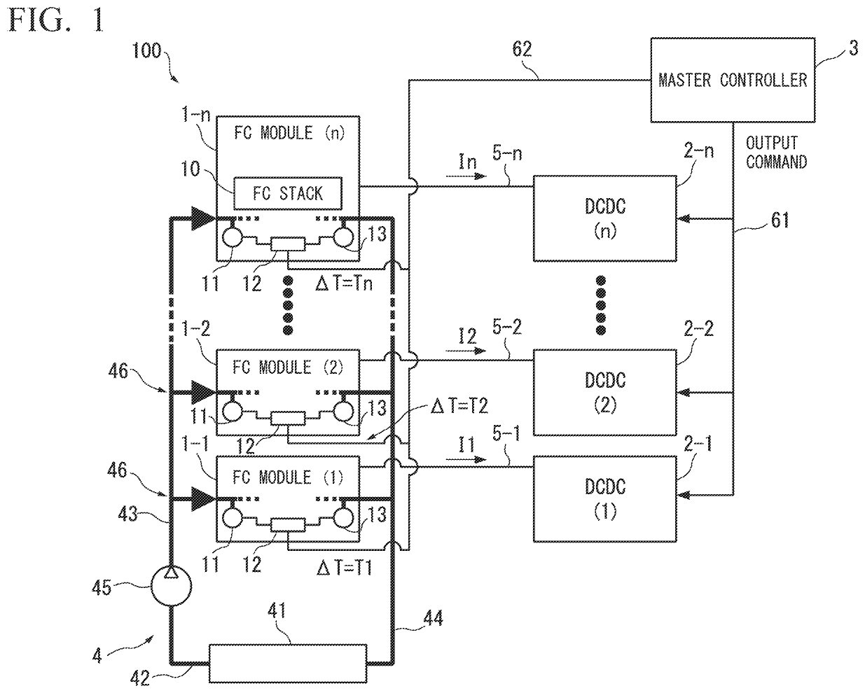

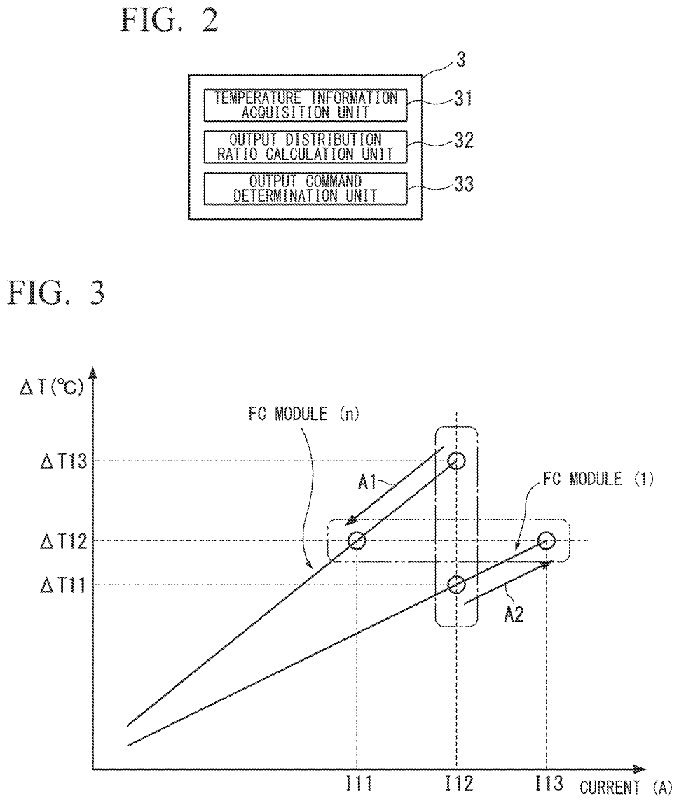

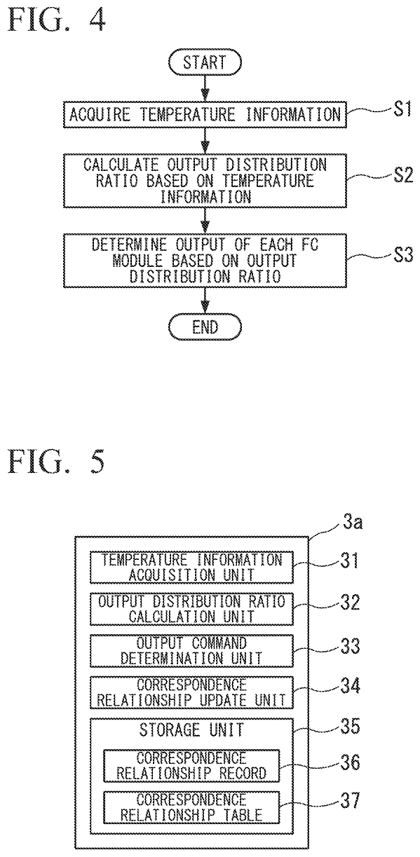

A first embodiment of the present disclosure will be described below with reference to FIGS. 1 to 4. FIG. 1 is a block diagram showing a configuration example of a fuel cell system according to an embodiment of the present disclosure. FIG. 2 is a block diagram showing a functional configuration of a control device according to the first embodiment of the present disclosure. FIG. 3 is a schematic diagram for describing an operation example of the control device according to the embodiment of the present disclosure. FIG. 4 is a flowchart showing an operation example of the control device according to the embodiment of the present disclosure.

### (Fuel Cell System)

A fuel cell system 100 shown in FIG. 1 includes n pieces of a fuel cell (FC) module (1) 1-1, an FC module (2) 1-2, . . . , and an FC module (n) 1-n, n pieces of a direct current (DC)-DC converter (1) 2-1, a DC-DC converter (2) 2-2, . . . , and a DC-DC converter (n) 2-n, a master controller 3, and a cooling system 4. Here, n is an integer of 2 or more. Note that, in the following description, the FC module (1) 1-1, the FC module (2) 1-2, . . . , and the FC module (n) 1-n are sometimes collectively referred to as FC modules 1. In addition, the DC-DC converter (1) 2-1, the DC-DC converter (2) 2-2, . . . , and the DC-DC converter (n) 2-n are sometimes collectively referred to as DC-DC converters 2.

The fuel cell system 100 shown in FIG. 1 is used in, for example, a vehicle such as a work machine, a bus, and a train, a means of transportation such as a marine vessel, a power generation system for home use, business use, and industrial use, and the like. Hereinafter, in a case where a specific example is given for another device or the like connected to the fuel cell system 100 (not shown), it is assumed that the fuel cell system 100 is mounted on a dump truck.

### (FC Module)

Each of the FC modules 1 includes an FC stack 10. Note that, in FIG. 1, only the FC stack 10 of the FC module (n) 1-n is shown. The FC stack 10 is constructed by stacking a plurality of FC cells. The FC stack 10 is connected to a hydrogen supply mechanism, an air (oxygen) supply mechanism, an exhaust mechanism, and the like (not shown), and generates electricity by a reaction between hydrogen and oxygen in the air. The FC module (1) 1-1, the FC module (2) 1-2, . . . , and the FC module (n) 1-n output the generated DC power to the DC-DC converter (1) 2-1, the DC-DC converter (2) 2-2, . . . and the DC-DC converter (n) 2-n via cables 5-1, 5-2, . . . , and 5-n. In addition, the FC stack 10 is cooled by a refrigerant (hereinafter referred to as cooling water) supplied by the cooling system 4. Each FC module 1 further includes a temperature sensor 11, a control device 12, and a temperature sensor 13. The temperature sensor 11 measures an inlet temperature of the cooling water supplied to each FC module 1. The temperature sensor 13 measures an outlet temperature of cooling water supplied to each FC module 1. The control device 12 acquires the inlet temperature of the cooling water measured by the temperature sensor 11 and the outlet temperature of the cooling water measured by the temperature sensor 13. Further, the control device 12 calculates a cooling water inlet/outlet temperature difference ΔT, which is a temperature difference between the inlet temperature and the outlet temperature of the cooling water. In addition, the control device 12 outputs temperature information, which is data indicating the calculated cooling water inlet/outlet temperature difference ΔT, to the master controller 3 via a communication line 62. The cooling water inlet/outlet temperature difference ΔT is a value corresponding to the amount of heat generation of each FC stack 10 and the flow rate of the cooling water. The greater the amount of heat generation is, the greater the cooling water inlet/outlet temperature difference ΔT is. In addition, the smaller the flow rate is, the greater the cooling water inlet/outlet temperature difference ΔT is.

Note that the temperature sensor 11 and the temperature sensor 13 may be provided outside the FC module 1. Furthermore, one temperature sensor 11 may be provided for a plurality of FC modules 1, or the number of the temperature sensors 11 may be less than the number of the FC modules 1. In addition, each of the temperature sensors 11 and each of the temperature sensors 13 is an example of a temperature sensor provided so that a temperature of each of the fuel cell modules 1 according to the present disclosure is measurable.

In FIG. 1, the cooling water inlet/outlet temperature difference ΔT measured by the FC module (1) 1-1 is represented as T1, the cooling water inlet/outlet temperature difference ΔT measured by the FC module (2) 1-2 is represented as T2, and the cooling water inlet/outlet temperature difference ΔT measured by the FC module (n) 1-n is represented as Tn. In addition, the output current of the FC module (1) 1-1 is represented as I1, the output current of the FC module (2) 1-2 is represented as 12, and the output current of the FC module (n) 1-n is represented as In.

### (DC-DC Converter)

The DC-DC converter 2 receives the DC power input from the FC module 1 as an input, controls the output voltage and output current of the DC-DC converter 2 to predetermined values, and outputs them to a load (not shown) on the basis of an output command sent from the master controller 3 via the communication line 61. The output command includes, for example, an output current command indicating a command value of the output current of the FC module 1 or an output power command indicating a command value of the output power of the FC module 1. In addition, the output command includes a command indicating a command value of the output current of the DC-DC converter 2 and a command value of the output voltage of the DC-DC converter 2. The load (not shown) is, for example, a storage battery, an inverter, a motor connected to the inverter, and the like. The DC-DC converter 2 controls the output current of the FC module 1 for each FC module 1 on the basis of the output current command included in the output command. Alternatively, the DC-DC converter 2 controls the output power of the FC module 1 for each FC module 1 on the basis of the output power command included in the output command. Note that a plurality of DC-DC converters 2 may be integrally configured. In addition, the plurality of DC-DC converters 2 are an example of an output current control circuit provided so that an output current from each of the fuel cell modules 1 according to the present disclosure is individually controllable.

Note that the outputs of the plurality of DC-DC converters 2 may be connected in parallel, in series, or a combination of in parallel and in series. For example, in a case where the outputs of the respective DC-DC converters 2 are connected in parallel, each DC-DC converter 2 makes the output voltage of the DC-DC converter 2 the same and adjusts the output current of the DC-DC converter 2 to adjust the output current (or output power) from each FC module 1. For example, in a case where the outputs of the respective DC-DC converters 2 are connected in series, each DC-DC converter 2 makes the output current of the DC-DC converter 2 the same and adjusts the output voltage of the DC-DC converter 2 to adjust the output current (or output power) from each FC module 1.

### (Cooling System)

The cooling system 4 includes a radiator (cooler) 41, pipes 42, 43, and 44, and a pump 45. The cooling water cooled by the radiator 41 is supplied to each FC module 1 via the pipe 42, the pump 45 and the pipe 43. In this case, cooling water is supplied from each branch point 46 of the pipe 43 to each FC module 1. Moreover, the cooling water discharged from each FC module 1 is returned to the radiator 41 via the pipe 44. The cooling system 4 shown in FIG. 4 shares a set of a radiator 41 and a pump 45 for each FC module 1.

As the system that cools the plurality of FC modules, for example, a case where a set of the radiator 41 and the pump 45 is shared for each FC module 1 (referred to as a centralized cooling system) as in the present embodiment, and a case where a set of the radiator and the pump is individually provided for each FC module (referred to as an individual cooling system) are conceivable. For example, in a case where a plurality of fuel cell modules of about two are used in combination, it is conceivable that an individual cooling system can be employed. However, in a case where an efficient radiator mounting location in a vehicle or the like is limited to the front of the vehicle or the like, in the individual cooling system, a cooling water line is complicated and the vehicle-mounted space is limited, which is a problem. On the other hand, for example, in a case where three or more fuel cell modules are used in combination, it is conceivable that a method of using a common cooling water line and providing one pump for supplying cooling water and one radiator for exhausting heat in the entire system, as in the case of a centralized cooling system, for example, may be advantageous. With the centralized cooling system, the cooling water lines are compact, and the number of parts is reduced, thereby simplifying the system.

However, in the case of a centralized cooling system, the distribution of the amount of cooling water varies depending on the length of the piping to each fuel cell module and the number of branches. This results in an increase in temperature in the fuel cell module where the flow rate of cooling water is relatively reduced. As the entire system, the cooling water pump and radiator fan are controlled to keep the temperature of the fuel cell module at an appropriate level. However, with this control, the total output as the entire system is limited by the fuel cell module in which the cooling water flow rate is relatively decreased, and the entire output is decreased. In addition, with this control, the temperature variation between the fuel cell modules is not alleviated. Therefore, the variation in deterioration rate of each fuel cell module cannot be suppressed, and the lifetime of the entire fuel cell module is shortened. It is generally known that the influence of the temperature as a factor of deterioration of the fuel cell module is large, and the deterioration accelerates in a case where the fuel cell module is operated under a high temperature.

In addition, the same applies to a case where the performance of the plurality of fuel cell modules varies, as described below. Since a decrease in performance leads to an increase in the amount of heat generation, the cooling water pump and radiator fan are controlled to keep the temperature of the fuel cell module at an appropriate level even in a case where its performance has decreased. In this case as well, the total output as the entire system is limited by the fuel cell module having a relatively large decrease in performance, and the overall output decreases. In addition, with this control, the temperature variation between the fuel cell modules is not alleviated. Therefore, the variation in deterioration rate of each fuel cell module cannot be suppressed, and the lifetime of the entire fuel cell module is shortened.

Therefore, in the present embodiment, the master controller 3 controls each DC-DC converter 2 on the basis of the temperature information acquired through the temperature sensors 11 and 13 to suppress the temperature variation between the fuel cell modules 1. Note that the master controller 3 is an example of a control device that controls the output current control circuit according to the present disclosure.

### (Master Controller)

FIG. 2 is a block diagram showing a functional configuration of the master controller 3 (control device). The master controller 3 can be configured using a computer such as a microcomputer, and peripheral circuits and peripheral devices of the computer. Then, the master controller 3 includes a temperature information acquisition unit 31, an output distribution ratio calculation unit 32, and an output command determination unit 33 shown in FIG. 2 as a functional configuration composed of a combination of hardware, such as a computer, and software, such as a program executed by the computer. In addition, the computer may be configured using a custom large scale integrated circuit (LSI), such as a programmable logic device (PLD). Examples of PLDs include a programmable array logic (PAL), a generic array logic (GAL), a complex programmable logic device (CPLD), and a field programmable gate array (FPGA). In this case, some or all of functions realized by a processor may be realized by the corresponding integrated circuit.

The temperature information acquisition unit 31 acquires temperature information, which is data indicating the cooling water inlet/outlet temperature difference ΔT, from each FC module 1.

The output distribution ratio calculation unit 32 calculates an output distribution ratio, which is the ratio of the output current from each FC module 1 to the total output current, which is the total value of the output currents from the respective FC modules 1, on the basis of the temperature information. The output distribution ratio is a value set for each FC module 1 and indicates the ratio to the total output current. The value of each output distribution ratio of each FC module 1 takes, for example, a value from 0 to 1, assuming that the total value of each output distribution ratio is 1. The output distribution ratio calculation unit 32 calculates each output distribution ratio so that the output current from the fuel cell module 1 having a relatively high temperature is reduced and the output current from the fuel cell module 1 having a relatively low temperature is increased. The total output current can be determined, for example, according to a required value of a driving force of a motor that serves as a load. The output distribution ratio corresponds to a distribution ratio according to the present disclosure.

Here, an example of a method for calculating the output distribution ratio by the output distribution ratio calculation unit 32 will be described with reference to FIG. 3. FIG. 3 shows an example of a correspondence relationship between the output current and the cooling water inlet/outlet temperature difference ΔT in the FC module (1) and the FC module (n), with the output current of each FC module 1 on the horizontal axis and the cooling water inlet/outlet temperature difference ΔT of each FC module 1 on the vertical axis. In the example shown in FIG. 3, in a case where the output current is I12, the cooling water inlet/outlet temperature difference ΔT in the FC module (n) is ΔT13, and the cooling water inlet/outlet temperature difference ΔT in the FC module (1) is ΔT11. In addition, in a case where the output current is I11, the cooling water inlet/outlet temperature difference ΔT in the FC module (n) is ΔT12. In addition, in a case where the output current is I13, the cooling water inlet/outlet temperature difference ΔT in the FC module (1) is ΔT12. Note that I11<I12<I13, and ΔT11<ΔT12<ΔT13.

As an example, a case where the power required by a vehicle is supplied from a plurality of fuel cell modules 1 via a plurality of DC-DC converters 2 connected in parallel is considered. The simplest method is to divide the required power of the vehicle by the number n of fuel cell modules 1, and to request the master controller 3 to supply equal power to each of the fuel cell modules 1. However, in the cooling system in which a plurality of fuel cell modules 1 are connected in parallel and are centrally managed, a situation is assumed in which the amount of heat generation is different for each fuel cell module 1 due to distribution variation of cooling water or performance variation of the fuel cell module 1. In this case and a case where uniform power (current I12) is required, a situation arises in which the difference in the cooling water inlet/outlet temperature difference ΔT is generated from the difference in the amount of heat generation as shown by being surrounded by a one-dot chain line in FIG. 3. Specifically, in the fuel cell module 1 in which the amount of heat generation is large, the cooling water inlet/outlet temperature difference ΔT is increased. As described above, in a case where this state is continued, the deterioration of the fuel cell module 1 in a high temperature state proceeds, and the lifetime will be shortened. Therefore, the required power on each of the fuel cell modules 1 is changed to equalize the cooling water inlet/outlet temperature difference ΔT of the plurality of fuel cell modules 1. The power control is performed by controlling the output of the DC-DC converter 2. Specifically, as shown by being surrounded by a two-dot chain line in FIG. 3, a fuel cell module having a relatively low cooling water inlet/outlet temperature difference ΔT increases the required output (required current) (arrow A2). On the other hand, a fuel cell module having a relatively high cooling water inlet/outlet temperature difference ΔT reduces the required power (required current) (arrow A1). However, in this case, another constraint condition is that the sum of the outputs of the plurality of fuel cell modules 1 satisfies the vehicle request, and this determines the required current fluctuation allowance for each fuel cell module 1.

The correspondence relationship between the output current of the fuel cell module 1 and the cooling water inlet/outlet temperature difference ΔT shown in FIG. 3 may be calculated, for example, by constructing an equivalent model according to the disposition of each FC module 1 and the cooling system 4, the piping, the amount of power generation, the ambient temperature, the experimental result, and the like. Alternatively, the correspondence relationship between the output current and the cooling water inlet/outlet temperature difference ΔT may be appropriately acquired or updated based on the operation record of the fuel cell module 1 in an actual vehicle. For example, the output current and the cooling water inlet/outlet temperature difference ΔT can be acquired on the basis of an average value of the output current and the cooling water inlet/outlet temperature difference ΔT for a predetermined time. Note that the operation record may be acquired only in a state in which the vehicle is normally driving, for example, except for a start time and a stop time.

In this case, the output distribution ratio calculation unit 32 calculates the output distribution ratio with reference to the correspondence relationship between the output current of each fuel cell module 1 and the cooling water inlet/outlet temperature difference ΔT as shown in FIG. 3.

Alternatively, the output distribution ratio calculation unit 32 may calculate the output distribution ratio as follows. That is, first, the output distribution ratio calculation unit 32 calculates, as a reference value, for example, an average value, a median value, or the like of the cooling water inlet/outlet temperature difference ΔT=T1, T2, . . . , Tn of the FC modules (1), (2), . . . , (n). Next, the output distribution ratio calculation unit 32 reduces the output distribution ratio of the FC module 1 in which the cooling water inlet/outlet temperature difference ΔT is larger than the reference value, and increases the output distribution ratio of the FC module 1 in which the cooling water inlet/outlet temperature difference ΔT is smaller than the reference value. After a predetermined time has elapsed, the output distribution ratio calculation unit 32 changes the output distribution ratio again in the same manner. In this case, the output distribution ratio is adjusted so that the difference between the cooling water inlet/outlet temperature difference ΔT of each FC module 1 and the reference value is reduced.

In addition, the output command determination unit 33 determines the output of each FC module 1 on the basis of the total output current and the output distribution ratio calculated by the output distribution ratio calculation unit 32, and transmits an output command to each DC-DC converter 2.

Next, a process of determining an output command by the master controller 3 will be described with reference to FIG. 4. The process shown in FIG. 4 is repeatedly executed, for example, at a predetermined period. In a case where the process shown in FIG. 4 is started, first, the temperature information acquisition unit 31 acquires temperature information from each FC module 1 (step S1). Next, the output distribution ratio calculation unit 32 calculates the output distribution ratio on the basis of the temperature information (step S2). Next, the output command determination unit 33 determines the output of each FC module 1 on the basis of the total output current and the output distribution ratio, and transmits an output command to each DC-DC converter 2 (step S3).

As described above, in the present embodiment, the master controller 3 (control device) controls the DC-DC converter 2 (output current control circuit) provided so that the output current from each of the fuel cell modules 1 is individually controllable on the basis of the temperature information acquired through the temperature sensors 11 and 13 provided so that the temperature of each of the fuel cell modules 1 is measurable. According to this configuration, temperature variation between a plurality of fuel cell modules 1 can be suppressed. Therefore, according to the present embodiment, it is possible to effectively use the power generation capacity of the fuel cell system 100 consisting of a plurality of fuel cell modules 1. In addition, according to the present embodiment, it is possible to equalize the deterioration of the plurality of fuel cell modules 1 and to extend the system lifetime.

### Modification Example

In the fuel cell system 100 shown in FIG. 1, for example, the DC-DC converter 2 can be configured integrally with the FC module 1, or one of the plurality of FC modules 1 can include the master controller 3. The temperature sensor may be, for example, a temperature sensor that measures a temperature of one location or a plurality of locations of the FC stack 10 instead of or in addition to the temperature of the cooling water. In this case, temperature information is the temperature itself.

### Second Embodiment

A second embodiment of the present disclosure will be described with reference to FIG. 5. The second embodiment is different from the first embodiment in that the configuration of a master controller 3a shown in FIG. 5 which corresponds to the master controller 3 shown in FIG. 1 is partially different. The master controller 3a shown in FIG. 5 includes, as additional components, a correspondence relationship update unit 34 and a storage unit 35 that stores a correspondence relationship record 36 and a correspondence relationship table 37, in comparison with the master controller 3 shown in FIG. 2. In the present embodiment, the correspondence relationship is a correspondence relationship between the output current and the cooling water inlet/outlet temperature difference ΔT, which is described with reference to FIG. 3. The correspondence relationship record 36 includes, for example, the operation records for three times in a case where the start and stop of the vehicle is one time. The correspondence relationship table 37 is a table that represents a correspondence relationship between the output current and the cooling water inlet/outlet temperature difference ΔT created or updated on the basis of the correspondence relationship record 36 for each of the FC modules 1.

The correspondence relationship update unit 34 acquires, for example, an average value of the output current (command value) of each FC module 1 for a predetermined time and an average value of the cooling water inlet/outlet temperature difference ΔT for a predetermined time during actual driving of the vehicle, and stores the acquired average values in the storage unit 35 as the correspondence relationship record 36. In addition, the correspondence relationship update unit 34 creates and updates the correspondence relationship table 37 on the basis of the correspondence relationship record 36.

Moreover, the output distribution ratio calculation unit 32 calculates the output distribution ratio with reference to the correspondence relationship table 37.

According to the present embodiment, the output distribution of each FC module 1 with respect to the required power can be quickly determined on the basis of the correspondence relationship table 37. In addition, it is also possible to correspond to the characteristics of the fuel cell that change with time.

Although the embodiments of the present invention have been described above in detail with reference to the drawings, the specific configuration is not limited to the above embodiments, and design modifications and the like are included within the scope of the gist of the present invention. Furthermore, part or all of the programs executed by the computer in the above embodiments can be distributed via a computer-readable recording medium or a communication line.

According to the fuel cell system and the control method of the present disclosure, a temperature variation between a plurality of fuel cell modules can be suppressed.

1. A fuel cell system comprising:
a plurality of fuel cell modules;
a temperature sensor configured to measure a temperature of each of the fuel cell modules;
an output current control circuit configured to individually control an output current from each of the fuel cell modules; and
a control device configured to control the output current control circuit on the basis of temperature information acquired through the temperature sensor.

2. The fuel cell system according to claim 1, wherein
the control device is configured to reduce an output current from the fuel cell module having a relatively high temperature, and to increase an output current from the fuel cell module having a relatively low temperature.

3. The fuel cell system according to claim 1, wherein
the temperature information is a temperature difference between an inlet temperature and an outlet temperature of a refrigerant of each of the plurality of fuel cell modules.

4. The fuel cell system according to claim 1, wherein
the control device is configured to calculate a distribution ratio of the output current from each of the plurality of fuel cell modules to a total output current from the plurality of fuel cell modules based on the total output current from the plurality of fuel cell modules and a correspondence relationship between the output current and the temperature information for each of the plurality of fuel cell modules, and to individually control the output current from each of the plurality of fuel cell modules so that the calculated distribution ratio is achieved.

5. The fuel cell system according to claim 4, wherein
the correspondence relationship is appropriately updated based on an operation record of the plurality of fuel cell modules.

6. The fuel cell system according to claim 1, wherein
a refrigerant of two or more of the plurality of fuel cell modules is cooled by a same cooler.

7. A control method for a fuel cell system including
a plurality of fuel cell modules,
a temperature sensor configured to measure a temperature of each of the fuel cell modules,
an output current control circuit configured to individually control an output current from each of the plurality of fuel cell modules, and
a control device configured to control the output current control circuit, the control method comprising:
via the control device,
controlling the output current control circuit on the basis of temperature information acquired through the temperature sensor.

8. The fuel cell system according to claim 2, wherein
the temperature information is a temperature difference between an inlet temperature and an outlet temperature of a refrigerant of each of the plurality of fuel cell modules.

9. The fuel cell system according to claim 8, wherein
the control device is configured to calculate a distribution ratio of the output current from each of the plurality of fuel cell modules to a total output current from the plurality of fuel cell modules based on the total output current from the plurality of fuel cell modules and a correspondence relationship between the output current and the temperature information for each of the plurality of fuel cell modules, and to individually control the output current from each of the plurality of fuel cell modules so that the calculated distribution ratio is achieved.

10. The fuel cell system according to claim 9, wherein
the correspondence relationship is appropriately updated based on an operation record of the plurality of fuel cell modules.

11. The fuel cell system according to claim 10, wherein
a refrigerant of two or more of the plurality of fuel cell modules is cooled by a same cooler.
